(19) United States
(12) Patent Application Publication
(10) Pub. No.: US 2021/0232136 A1
(43) Pub. Date: Jul. 29, 2021

(54) SYSTEMS AND METHODS FOR CLOUD EDGE TASK PERFORMANCE AND COMPUTING USING ROBOTS

(71) Applicant: Brain Corporation, San Diego, CA (US)

(72) Inventors: Cody Griffin, San Diego, CA (US); Tony Kinsley, San Diego, CA (US)

(21) Appl. No.: 17/231,566

(22) Filed: Apr. 15, 2021

Related U.S. Application Data
(63) Continuation of application No. PCT/US19/56483, filed on Oct. 16, 2019.
(60) Provisional application No. 62/746,400, filed on Oct. 16, 2018.

(51) Int. Cl. G05D 1/00; G05D 1/02; B25J 9/16

(52) U.S. Cl. CPC G05D 1/0022; G05D 1/0219; G05D 1/0027; G05D 2201/0216; G05D 1/0291; G05D 1/0225; B25J 9/1679; G05D 1/0016

(57) ABSTRACT

Systems and methods for cloud edge task performance and computing using robots are disclosed herein. According to at least one non-limiting exemplary embodiment, a cloud server may utilize a robotic network, comprising a plurality of robots, communicatively coupled to the cloud server to collect data, perform physical tasks, perform a computational function, or a combination thereof in a distributed fashion.

### PRIORITY

This application is a continuation of International Patent Application No. PCT/US19/56483 filed Oct. 16, 2019 and claims the benefit of U.S. Provisional Patent Application Ser. No. 62/746,400 filed on Oct. 16, 2018 under 35 U.S.C. § 119, the entire disclosure of each are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application generally relates to robotics, and more specifically to systems and methods for cloud edge task performance and computing using robots.

### Background

Currently, a plurality of robots may operate within an environment, the plurality of robots may include different robots of different functionality or capabilities. These robots may operate independently to perform tasks of which they are best suited or programmed to execute.

A plurality of robots of different functionality and/or capabilities operating within an environment may work in tandem, simultaneously, or cooperatively, to perform tasks efficiently, wherein working in tandem may require an external server to effectuate the control of at least some of the plurality of robots. Working in tandem may enhance the efficiency, reduce time, and reduce a computational load to an external server performing a task.

Additionally, a plurality of robots working in tandem may be able to accomplish tasks, which robots acting individually may not be able to perform. Accordingly, there is a need in the art for systems and methods for cloud edge task performance and computing using robots

### SUMMARY

The foregoing needs are satisfied by the present disclosure, which provides for, inter alia, systems and methods for cloud edge task performance and computing using robots.

Exemplary embodiments described herein have innovative features, no single one of which is indispensable or solely responsible for their desirable attributes. Without limiting the scope of the claims, some of the advantageous features will now be summarized.

According to at least one non-limiting exemplary embodiment, a system comprising a cloud server communicatively coupled to a robot network comprising a plurality of robots, is disclosed. The cloud server may be configurable to receive an input from an operator and generate an output to the operator based on data gathered by the plurality of robots on the robot network. The cloud server may further be configurable to generate an instruction to be executed by the robot network, the instruction may configure the robot network to compute and/or collect data necessary to respond to the operator input.

According to at least one non-limiting exemplary embodiment, a method for collecting data, performing a task, and/or performing a computational function using a distributed robot network is disclosed. The method may include a cloud server receiving an operator input, generating an instruction to be executed by the robot network, and generating an operator output based on data collected during execution of the instruction by the robot network. The method may additionally include utilizing data collected by the robot network during execution of instructions to simultaneously respond to other operator inputs.

Example embodiments disclosed herein are directed to methods, systems and non-transitory computer readable mediums that may have computer readable instructions stored thereon, that when executed by at least one processor or processing device, configure the at least one processing device to, receive an operator input comprising instructions for a robot network, the robot network comprising a plurality of independently operable robots that are communicatively coupled to each other in an environment; transmit the instructions to at least a first sub-set of robots in the robot network such that the first sub-set of robots execute the instructions in the environment, the instructions comprising a plurality of tasks to be performed by the first sub-set of robots such that a respective task of the plurality of tasks is assigned to a respective robot of the first sub-set of robots based on bandwidth of the respective robot; receive data collected by the first sub-set of robots during simultaneous performance of the plurality of tasks by the first sub-set of robots in the environment; and generate an operator output based on the data collected by the first sub-set of robots.

The methods, systems and non-transitory computer readable mediums disclosed herein are further configurable to execute the computer readable instructions to, transmit the instructions to the first sub-set of robots in the robot network only if response to the operator input is not previously stored in the memory. Wherein, the transmission of the instructions to the first sub-set of robots configures the respective robot to navigate from a first location to a second location and collect data on one or more items at the second location, and transmit the data collected on the one or more items to the at least one controller. Further, wherein the transmission of the instructions to the first sub-set of robots configures the respective robot to, retrieve one or more items from a designated pick-up location and drop the one or more items at a designated drop-off location, and transmit data to the at least one processing device simultaneously as the one or more items are relocated from the pick-up location to the drop-off location.

The methods, systems and non-transitory computer readable mediums disclosed wherein the transmission of the instructions to the first sub-set of robots configures the respective robot to, receive a plurality of operator inputs, each of the plurality of operator inputs comprises a plurality of tasks to be performed by set of the plurality of robots. Wherein, the respective robot of the plurality of robots performs the respective task in the plurality of tasks only if the respective task is not previously performed by a different robot assigned the respective task via a respective operator input. Wherein, each robot updates other robots in the plurality of robots upon completion of the respective task assigned to the respective robot. And, wherein the respective task of the plurality of tasks are assigned based at least on functionality and capabilities of the respective robot, and the plurality of tasks include at least one of data collection, physical tasks and computational functions.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some exemplary embodiments of this disclosure.

FIG. 1B is a functional block diagram of a controller or processing device in accordance with some exemplary embodiments of this disclosure.

FIG. 2 is a functional block diagram of a cloud server in accordance with some exemplary embodiments of this disclosure.

FIG. 3 is a functional block diagram illustrating a process for a cloud server to receive an operator input and generate an operator response utilizing data from a robot network, according to an exemplary embodiment.

FIG. 4 is a process flow diagram illustrating a method for a cloud server to receive an operator input and generate an operator response utilizing data from a robot network, according to an exemplary embodiment.

FIG. 5 is a process flow diagram illustrating a method for a robot on a robot network to receive and execute an instruction from a cloud server, according to an exemplary embodiment.

FIG. 6 is a top view of a robot performing a data collection task based on an instruction received from a cloud server, according to an exemplary embodiment.

FIG. 7A-C is a top view of a robot performing various physical tasks based on an instruction received from a cloud server, according to an exemplary embodiment.

FIG. 8 is a top view of a robot performing a computational function task based on an instruction received from a cloud server, according to an exemplary embodiment.

FIG. 9 is a data table illustrating a plurality of robots on a robot network and features thereof, according to an exemplary embodiment.

FIG. 10 is a data table illustrating an instruction queue comprising a plurality of instructions and tasks for a robot network, according to an exemplary embodiment.

All Figures disclosed herein are © Copyright 2018 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting the scope of the disclosure being defined by the appended claims and equivalents thereof.

The present disclosure provides for systems and methods for cloud edge computing and task performance using robots.

As used herein, a robot may include mechanical and/or virtual entities configurable to carry out a complex series of tasks or actions autonomously. In some exemplary embodiments, robots may be machines that are guided and/or instructed by computer programs and/or electronic circuitry. In some exemplary embodiments, robots may include electro-mechanical components that are configurable for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a robot network or network of robots may comprise a plurality of robots communicatively coupled to each other and/or coupled to an external cloud server. The plurality of robots may communicate data to other robots on the robot network and/or to an external cloud server. The plurality of robots on the robot network may include robots of different or the same functionalities. A robot network communicating with a server may comprise a plurality of robots on the robot network communicating with the server.

As used herein, a cloud server may comprise a server configurable to receive, request, process, and/or return data to robots, humans, and/or other devices. A cloud server may be hosted at the same location as a network of robots communicatively coupled to the cloud server or may be at a separate location. A cloud server may be communicatively coupled to a robot network and may generate instructions to effectuate the control of robots on the robot network.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor or processing device, microprocessor, and/or digital processor may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) allow robots to accomplish tasks efficiently; (ii) allow human operators to utilize a network of robots to perform tasks; and (iii) reduce a computational load to a cloud server effectuating the control of a plurality of robots. Other advantages are readily discernable by one having ordinary skill in the art given the contents of the present disclosure.

According to at least one non-limiting exemplary embodiment, a system comprising a cloud server communicatively coupled to a robot network comprising a plurality of robots is disclosed. The cloud server may be configurable to receive an input from an operator and generate an output to the operator based on data gathered by the plurality of robots on the robot network. The cloud server may be further configurable to generate an instruction to be executed by the robot network, the instruction may configure the robot network to compute and/or collect data necessary to respond to the operator input.

According to at least one non-limiting exemplary embodiment, a method for collecting data, performing a task, and/or performing a computational function using a distributed robot network is disclosed. The method may include a cloud server receiving an operator input, generating an instruction to be executed by the robot network, and generating an operator output based on data collected during execution of the instruction by the robot network. The method may additionally include utilizing data collected by the robot network during execution of instructions to simultaneously respond to other operator inputs.

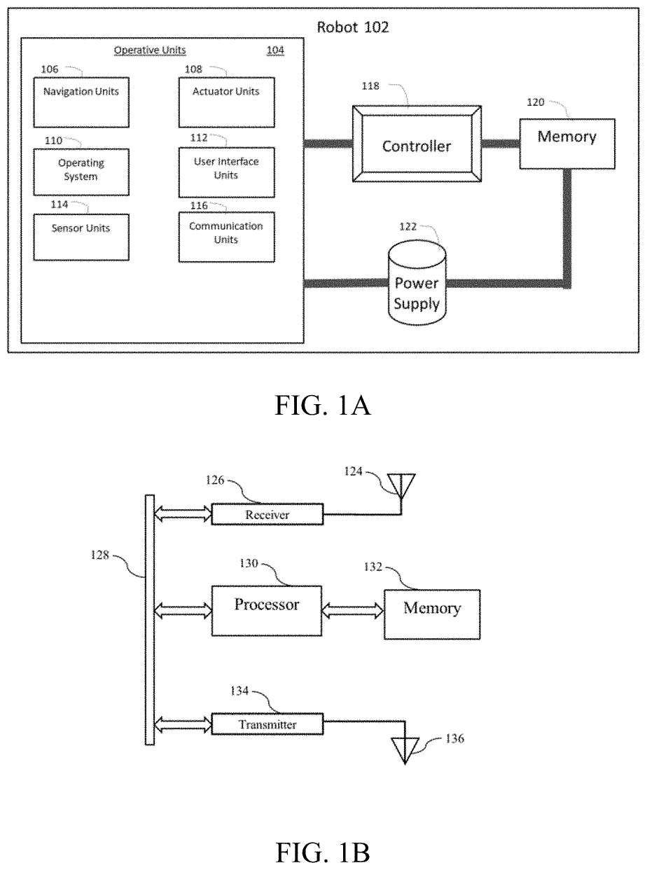

FIG. 1A is a functional block diagram of a robot 102 in accordance with some exemplary embodiments of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, processing device, microprocessor, and/or digital processor may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors or processing device (e.g., neuromorphic processors), and application-specific integrated circuits (“ASICs”). Such digital processors may be contained on a single unitary integrated circuit die, or distributed across multiple components.

Controller 118 may be operatively and/or communicatively coupled to memory 120. Memory 120 may include any type of integrated circuit or other storage device configurable to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc.

Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configurable to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configurable to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configurable to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors or processing device. In some embodiments, a single controller (e.g., controller 118) may serve as the various controllers and/or processors or processing device described. In other embodiments different controllers and/or processors may be used, such as controllers and/or processors or processing device used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configurable to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configurable to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LIDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on measurements. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configurable to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configurable to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configurable to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configurable to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configurable to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configurable to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configurable to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto or coupled to a robot 102, such as in an integrated system. However, according to exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used here on out, a robot 102, a controller 118, or any other controller, processor, processing device, or robot performing a task illustrated in the figures below comprises a controller executing computer readable instructions stored on a non-transitory computer readable storage apparatus, such as memory 120, as would be appreciated by one skilled in the art.

Next referring to FIG. 1B, the architecture of the specialized controller 118 used in the system shown in FIG. 1A is illustrated according to an exemplary embodiment. As illustrated in FIG. 1B, the specialized controller 118 may include a data bus 128, a receiver 126, a transmitter 134, at least one processing device 130, and a memory 132. The receiver 126, the processing device 130 and the transmitter 134 all communicate with each other via the data bus 128. The processing device 130 is a specialized processing device configurable to execute specialized algorithms. The processing device 130 is configurable to access the memory 132 which stores computer code or instructions in order for the processing device 130 to execute the specialized algorithms. As illustrated in FIG. 1B, memory 132 may comprise some, none, different, or all of the features of memory 120 previously illustrated in FIG. 1A. Memory 120, 132 may include at least one table for storing data therein. The at least one table may be a self-referential table such that data stored in one segment of the table may be related or tied to another segment of the table. For example, data stored in a first row (rᵢ) and first column (cᵢ) may relate to one more data points stored in one or more different row (r_{z}) and different column (c_{z}), wherein rᵢ, cᵢ, r_{z} and c_{z} are integral numbers greater than one.

The algorithms executed by the processing device 130 of the controller 118 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing by the specialized controller 118. The receiver 126 communicates these received signals to the processing device 130 via the data bus 128. As one skilled in the art would appreciate, the data bus 128 is the means of communication between the different components—receiver, processing device, and transmitter—in the specialized controller 118. The processing device 130 executes the algorithms, as discussed below, by accessing specialized computer-readable instructions from the memory 132. Further detailed description as to the processing device 130 executing the specialized algorithms in receiving, processing and transmitting of these signals is discussed above with respect to FIG. 1A.

The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processing device 130 may communicate output signals to transmitter 134 via data bus 128 as illustrated. The transmitter 134 may be configurable to further communicate the output signals to a plurality of operative units 104 illustrated by signal output 136.

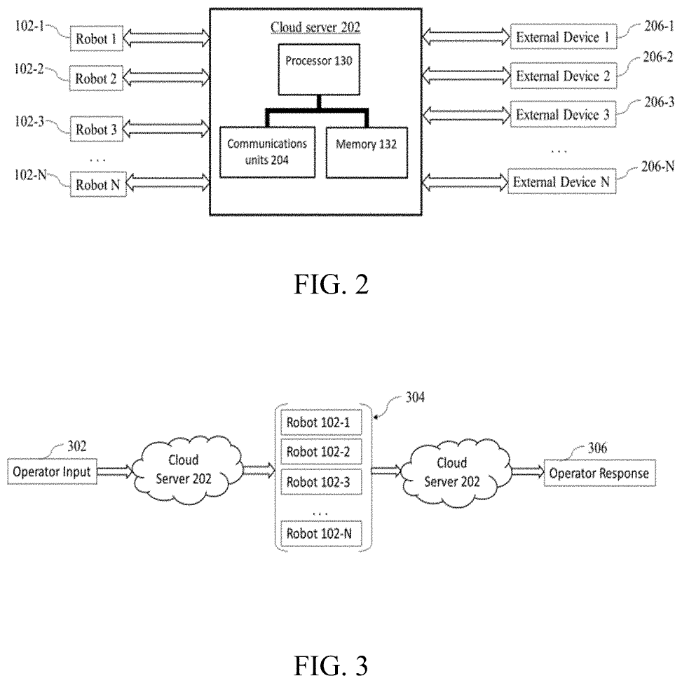

One of ordinary skill in the art would appreciate that the architecture illustrated in FIG. 1B may illustrate an external cloud server architecture configurable to effectuate the control of a robotic apparatus from a remote location. That is, the cloud server may also include a data bus, a receiver, a transmitter, a processing device, and a memory that stores specialized computer readable instructions thereon as illustrated below in FIG. 2.

FIG. 2 illustrates a functional block diagram of a cloud server 202 in accordance with some exemplary embodiments of the present disclosure. The cloud server 202 may comprise a substantially similar system architecture as the system architecture illustrated in FIG. 1B above, wherein the cloud server 202 may comprise a processing device 130 and a memory 132. The cloud server 202 may additionally comprise a communications unit 204 configurable to communicate signals between the cloud server 202 and a plurality of communicatively coupled robots 102 and external devices 206. The communications unit 204 may comprise a receiver 126 and a transmitter 134, as illustrated above in FIG. 1B. Robots 102 communicatively coupled to the cloud server 202 may send and receive data comprising, for example, sensor data, parameters of an environment (e.g., localization parameters of objects, route data, etc.), tasks to accomplish by the robots 102, and/or inputs and outputs to and from one or more external devices 206. The plurality of robots 102 communicatively coupled to the cloud server 202 may form a robot network 304, illustrated below in FIG. 3.

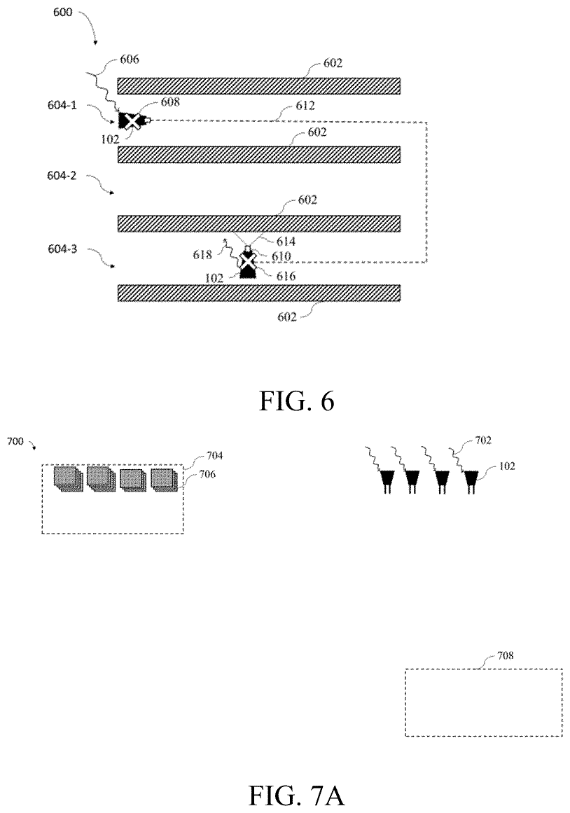

External devices 206 may comprise user interface units, closed-circuit television (CCTV) cameras, other cloud servers 202, and/or any other type of device communicatively coupled to the cloud server 202. The processor 130 of the cloud server 202 may utilize data from the a respective one or more of the plurality of external devices 206 to determine individualized tasks to be performed by a respective one or more of the plurality of robots 102 coupled to the cloud server 202, and/or execute instructions in memory 132 based on the received data from the external devices 206. For example, an external device 206 may be a user interface, wherein data from the user interface may comprise a request for data, a physical task to be performed by the robots, and/or a request for a computation to be performed by the plurality of robots 102. The assigned individualized tasks to the robots 102 coupled to the cloud server 202 may enhance the efficiency of the cloud server 202 to respond to an input from the external device 206, as illustrated below in FIG. 6-8, as the work load required to respond to the input may be distributed among the plurality of robots 102.

According to at least one non-limiting exemplary embodiment, the individualized tasks may comprise the same, substantially similar, or different tasks between robots 102 of a plurality of robots 102 coupled to the cloud server 202. According to at least one non-limiting exemplary embodiment, the plurality of robots 102 and external devices 206 may comprise the same or different robots 102 and external devices 206.

FIG. 3 is a functional block diagram illustrating a process for a cloud server 202 to receive, process, and respond to an operator input 302, according to an exemplary embodiment. An operator input 302 may be received by the cloud server 202, from an external device 206, and/or a robot 102 communicatively coupled to the cloud server 202. The operator input 302 may comprise, for example, a request for data to be gathered by one or more robots 102, a physical task to be performed by one or more robots 102, a computational function to be performed by one or more robots 102, or a combination thereof. The operator input 302 may further include computer readable instructions to be executed by robots 102 on a robot network 304, wherein the instructions may be distributed by the cloud server 202.

The cloud server 202 may, upon receiving the operator input 302, distribute a plurality of tasks to a robot network 304, the robot network 304 comprising a plurality of robots 102 communicatively coupled to the cloud server 202. Robots 102 on the robot network 304 may comprise a plurality of identical robots 102 or a plurality of different robots 102. The distributed tasks may comprise individualized tasks for each robot 102 on the robot network 304 to perform. Data collected during performance of the individualized tasks of each robot 102 may be communicated to the cloud server 202 and utilized to respond to the operator input 302. According to at least one non-limiting exemplary embodiment, the collected data may additionally be used to respond to other operator inputs 302 simultaneously or used to respond to future operator inputs 302, wherein a response includes generating an operator response 306.

The robot network 304, which includes a plurality of robots 102-1 to 102-N may, upon completion of the distributed tasks, communicate any data collected during execution of the distributed tasks, the data comprising, for example, sensor data, odometry data, object localization data, controller 118 outputting one or more computed values, and/or any other form of data collected by the robots 102 on the robot network 304 during execution of the distributed tasks. The cloud server 202 may output an operator response 306 to the operator based on data collected by the robot network 304. The operator response 306 may include, but is not limited to, an output to a user interface, data communicated to an external device 206, and/or data communicated to one or more robots 102.

According to at least one non-limiting exemplary embodiment, a cloud server 202 may respond to an operator input 302 based on data stored in memory 132 of the cloud server 202 collected by a robot network 304 during prior to the operator input 302 (e.g., during execution of prior tasks as instructed by the cloud server 202). According to at least one non-limiting exemplary embodiment, a robot 102 on a robot network 304 may be used to input an operator input 302 in order to request for data, request for a physical task to be performed, and/or request for a computational function to be performed by a plurality of other robots 102 on the robot network 304, or a separate robot network 304. According to at least one non-limiting exemplary embodiment, an operator input may be received from an external server, such as a separate cloud server 202 or similar server.

According to at least one non-limiting exemplary embodiment, a cloud server 202 may further comprise a queueing system for handling a plurality of operator inputs 302 received if a robot network 304 coupled to the cloud server 202 is performing a separate task, wherein upon completion of the separate task the robot network 304 may access the queue to perform a first task in the queue. According to another non-limiting exemplary embodiment, a cloud server 202 may send a plurality of instructions to robots 102 on a robot network 304, wherein the robots 102 may comprise a similar queueing system for handling the plurality of instructions.

According to at least one non-limiting exemplary embodiment, a robot network 304 may be configurable to perform a plurality of tasks to respond to a plurality of operator inputs 302 simultaneously. For example, a first operator input 302 may request a physical task of moving objects from a first point to a second point and a second operator input 302 may request for a map of bumps on a floor between the first point and second point, wherein a respective robot in the robot network 304 may perform the physical task of moving objects while collecting elevation data of the floor to respond to the first and second operator inputs 302 simultaneously. In other words, a robot 102 in the robot network 304 may perform or execute simultaneously more than operator inputs.

A cloud server 202 distributing tasks to respond to an operator input 302 may enhance the efficiency of the cloud server 202 to respond to the operator input 302 as data required to respond to the operator input 302 (i.e., data required to generate an operator response 306) may be collected using a distributed system of robots 102. Collecting data using a distributed network of robots 102 may reduce a computational load to the cloud server 202 as the cloud server 202 may only be required to distribute tasks to a plurality of robots 102, thereby reducing the computational load to the cloud server 202 by using the distributed robot network 304 to perform physical tasks, gather data, and/or perform computations which may have otherwise been performed by a processing device 130 of the cloud server 202.

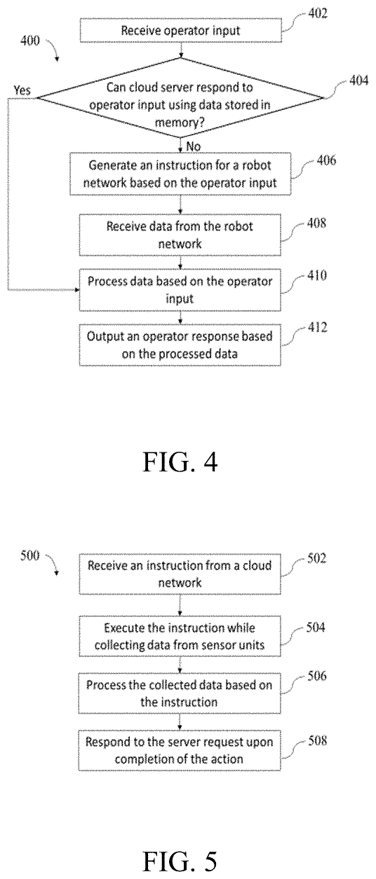

FIG. 4 is a process flow diagram illustrating a method 400 for a processing device 130 of a cloud server 202 to receive an operator input 302 and generate an operator response 306, illustrated in FIG. 3 above, according to an exemplary embodiment.

Block 402 illustrates the processing device 130 receiving an operator input 302. The operator input 302 may be received by an external device 206 and may comprise, for example, a request for data, a task to be performed, and/or a computational function to be performed by one or more robots 102 communicatively coupled to the cloud server 202. The operator input 302 may be received by the cloud server 202 from an external device 206 such as, for example, a user interface coupled to a user device such as a cellphone, laptop, or other handheld device, or a user interface coupled to a respective robot in the robot network 304.

Block 404 illustrates the processing device 130 determining if the operator input 302 may be responded to using data stored in memory 132 collected by a robot network 304 during execution of prior instructions. Data collected during execution of prior instructions may include sensor data, localization data, computational function outputs, and/or any other type of data collected by plurality of robots in the robot network 304 during execution of the prior instructions.

Upon the processing device 130 determining if the operator input 302 may be responded to using data stored in memory 132, the processing device 130 moves to block 410. However, if the processing device 130 determines that more data is required to be collected by the robot network 304 to respond to the operator input 302, the processing device 130 moves to block 406.

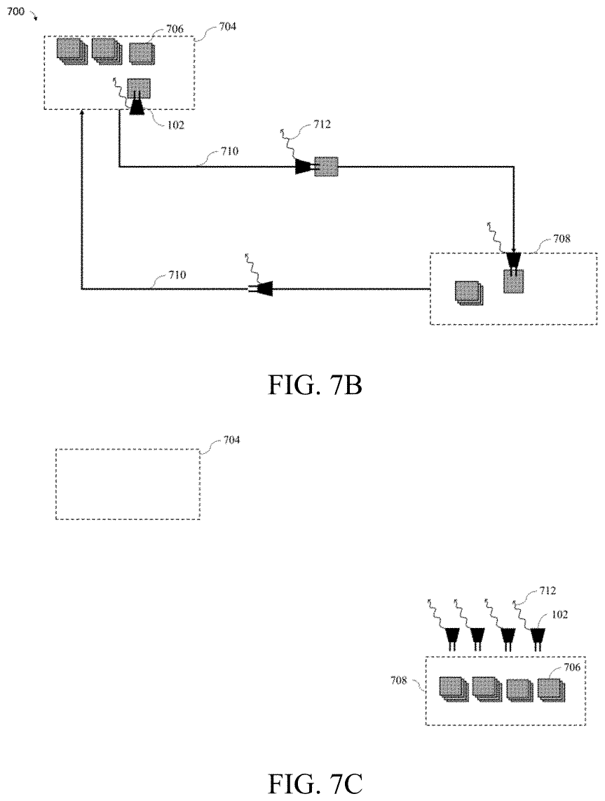

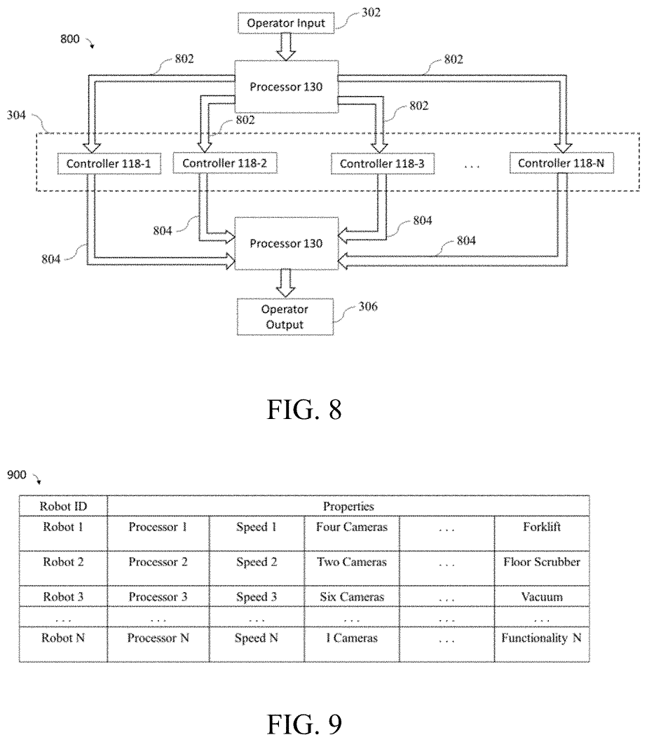

Block 406 illustrates the processing device 130 generating an instruction for a robot network 304, comprising a plurality of robots 102-1 to 102-N, based on the operator input 302. The instruction may comprise a high-level task for the robot network 304, wherein the high-level task may be accomplished by one or more robots 102 performing a set of lower level tasks. The tasks may include data acquisition by one or more robots 102 (as illustrated in FIG. 6), physical tasks (e.g., retrieving an object, moving an object, and/or any other similar physical task (as illustrated in FIG. 7A-C), computer readable instructions to be executed by a controller 118 of one or more robots 102 (as illustrated in FIG. 8), and/or any other task for one or more robots 102 on the robot network 304 to perform. For example, a cloud server 202 may request for a robot network 304 to relocate objects (high-level task) wherein the one or more robots 102 on the robot network 304 may localize the objects, navigate to the objects, pick up the objects, and place the objects at a new location (low-level tasks), wherein controllers 118 of the one or more robots 102 may determine the set of lower level tasks to be accomplished after the high-level task. One skilled in the art would appreciate the low-level and high-level tasks set forth herein are not limiting, and may include additional tasks that may be categorized as either high-level tasks or low-level tasks.

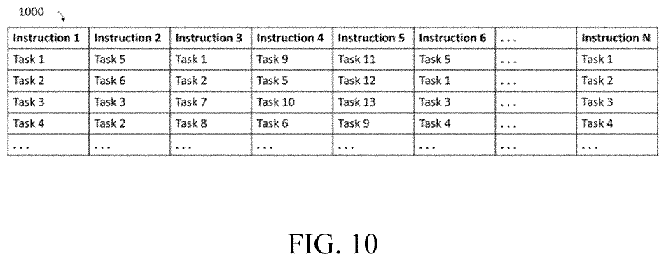

According to at least one non-limiting exemplary embodiment, a portion of data useful for generating an operator response 306 stored in memory 132 of a cloud server 202, wherein the instruction generated by the cloud server 202 may comprise tasks for one or more robots 102 to collect the remaining portion of data useful for generating an operator response 306, as illustrated below in FIG. 10.

According to at least one non-limiting exemplary embodiment, an instruction may be of any complexity, wherein an instruction of high complexity requires a large set of lower level tasks and vice versa. In other words, a cloud server 202 may effectuate the movements of each individual robot 102 by communicating a set of lower level tasks or may distribute a high-level task to the individual robots 102, wherein controllers 118 of the individual robots 102 may determine a set of lower level tasks to accomplish the high-level task. Stated differently, the cloud server 202 may designate a high-level task to a sub-set of robots in the robot network 304, and these sub-set of robots amongst themselves distribute the high-level task into a sub-set tasks such that each robot in the sub-set of robots is performing only a low-level task that corresponds to, or part of, the high-level task.

Block 408 illustrates the processing device 130 receiving data from the robot network 304, the received data being collected during execution of the instruction generated in block 404 by the plurality of robots 102. The received data may comprise sensor data from sensor units 114 of the plurality of robots 102, task completion data (e.g., a binary value corresponding to completion of a physical task), a computational result, and/or any other data gathered by the robot network 304 during execution and/or upon completion of the instruction.

Block 410 illustrates the processing device 130 processing the received data based on the operator input 302. The processing of the received data may include performing operations on sensor data (e.g., mapping), performing operations on computational results, encoding data to be outputted to a user interface, and/or any other form of data processing. The data processing performed in block 408 may be minimal, such as encoding the received data to output to a user interface, as a majority of computations, data collection, and task performance may be accomplished by the robots 102 on the robot network 304 based on the instruction generated in block 404.

Block 412 illustrates the processing device 130 outputting an operator response based on the processed data in block 408. The operator response 306 may be outputted to, for example, a user interface, an external server (e.g., another cloud server 202), and/or to a robot 102. The response may be configurable to respond to the operator input 302, received in block 402, based on data collected by the robot network 304.

FIG. 5 is a process flow diagram illustrating a method 500 for a controller 118 of a robot 102 on a robot network 304 to execute an instruction received by a cloud server 202, the instruction generated to respond to an operator input 302, according to an exemplary embodiment.

Block 502 illustrates the controller 118 of the robot 102 receiving the instruction from the cloud server 202. The instruction may comprise a task or set of tasks for the robot 102 to execute. The tasks may include data collection (e.g., using sensor units 114), a physical task to be performed (e.g., cleaning a floor, moving objects, etc.), a computational function to be performed (e.g., by receiving computer readable instructions to execute), and/or any other functionality of the robot 102.

According to at least one non-limiting exemplary embodiment, an instruction may comprise a high-level task to be abstracted upon by a controller 118 into a plurality of lower level tasks. For example, an instruction may comprise moving an object from a first point to a second point, wherein a controller 118 may abstract upon this task to perform a plurality of lower level tasks. These lower level tasks may include navigating to the first point, picking up the object, and navigating to the second point. One skilled in the art would appreciate that any instruction may be abstracted into any number of lower level tasks, wherein the level of abstraction may be based on the capabilities of a robot 102 in the robot network 304.

Block 504 illustrates the controller 118 executing the instruction, comprising a high-level task abstracted into a plurality of lower level tasks, while or subsequently collecting data from the sensor units 114 of the robot 102. While performing the lower level tasks based on the instruction, the lower level tasks determined by the controller 118 or the cloud server 202, the robot 102 may simultaneously collect and store some or all data generated by sensor units 114 of the robot 102 and/or outputted by the controller 118 (e.g., outputted by a controller 118 executing computer readable instructions received by the cloud server 202). The generated data from the sensor units 114 may be useful, at least in part, to the cloud server 202 to respond to an operator input 302. Some data generated may not be useful to the cloud server 202 to generate the response, however this data may be utilized by the cloud server 202 for future operator inputs 302. Accordingly, the robot 102 may collect, at minimum, data corresponding to execution of the tasks or outputted by the controller 118 during execution of the tasks (e.g., outputted by a controller 118 executing computer readable instructions received by the cloud server 202).

According to at least one non-limiting exemplary embodiment, an instruction may specify data to be collected by a robot 102 at specified locations, using specified sensors, at specified times, or a combination thereof. Doing so may preserve computational resources of the robot 102.

Block 506 illustrates the controller 118 processing the collected data based on the instruction. The processing of the collected data may include performing operations on sensor data (e.g., feature data of an object), performing operations on computational results, encoding data to be outputted to the cloud server 202, and/or any other form of data processing required by the instruction. A majority of data processing required to respond to an operator input 302 may be performed by the controller 118 of the robot 102, thereby minimizing a computational load imposed on a processing device 130 of the cloud server 202 by reducing the data processing performed by the processing device 130 of the cloud server 202.

Block 508 illustrates the controller 118 responding to the server instruction upon completion of the instruction by the robot network 304 based on the robot network 304 completing all tasks of which the instruction comprises. The response may include the processed data of block 506 and may be communicated using communications units 116 of the robot 102.

According to at least one non-limiting exemplary embodiment, some or all data collected during execution of the instruction by a robot 102 not useful for generating a response to the instruction may additionally be communicated to a cloud server 202 to enable the cloud server 202 to respond to future operator inputs 302.

Method 500 illustrates an individualized instruction for an individual robot 102 on a robot network 304, comprising a plurality of robots 102. One skilled in the art would appreciate that the method 500 may be applied to each of the plurality of robots 102 on the robot network 304, wherein an instruction may be communicated by a cloud server 202 to each individual robot 102 on the robot network 304 or may be communicated to the robot network 304 (i.e., all robots 102 on the robot network 304 receive the same instruction), wherein each individual robot 102 may determine tasks to be performed based on the instruction received by the robot network 304. Additionally, a plurality of instructions from a cloud server 202 may be executed by a single robot 102 simultaneously if the robot 102 is capable of performing the plurality of instructions simultaneously.

FIG. 6 illustrates a robot 102 performing a task based on a received instruction 606 from a cloud server 202 (not shown), the instruction comprising a request for data collection of items on a shelf 602 within a respective aisle 604 of a store 600, according to an exemplary embodiment. Instruction 606 may include a location 616, illustrated by a cross, within the store 600 for the robot 102 to navigate to and collect data on items at the location. Upon receiving the instruction 606 from the cloud server 202, the robot 102 may navigate from aisle one 604-1 to aisle three 604-3 following a route 612. The route 612 may be determined by a controller 118 of the robot 102 or communicated by the cloud server 202 as part of the instruction 606.

The robot 102 may navigate along route 612 around shelves 602 from a start point 608, illustrated by a cross, in aisle one 604-1 to aisle three 604-3 and stop at the location 616. Upon reaching the location 616, the robot 102 may utilize a sensor 610, of sensor units 114, to collect data on items on a shelf 602, as illustrated by sensor vision lines 614. The robot 102 may communicate the collected data to the cloud server 202 via a signal 618. Sensor 610 may comprise a camera sensor, for example, configurable to read bar codes and/or identify specific items on a shelf.

According to at least one non-limiting exemplary embodiment, a robot 102 may communicate additional sensor data using a wireless signal 618 to a cloud server 202, wherein the cloud server 202 may utilize the additional sensor data to respond to future operator inputs 302. For example, a future operator input 302 may be a request for data of other items on other shelves, wherein data from sensor 610 may be utilized if the robot 102 passed by the requested items along route 612 or other routes navigated in the past and collected sensor data of the requested items.

According to at least one non-limiting exemplary embodiment, a server instruction from a cloud server 202 may further utilize additional robots 102 within a store 600 (not shown) to collect data to respond to an operator input 302. For example, a plurality of robots 102 operating in a store 600 may receive an instruction from a cloud server 202 to collect data on features of the environment, such as items on shelves of the store 600 to determine the inventory of the store. The plurality of robots 102 may be used to accomplish the task of determining the inventory of the store 600 by navigating to separate aisles 604, utilizing a sensor 610 to count items on shelves 602 within a corresponding aisle 604, and communicate the data to the cloud server 202, wherein the cloud server 202 may utilize the accumulated data from the plurality of robots 102 to determine the inventory of the store 600.

According to at least one non-limiting exemplary embodiment, a data collection task may be performed simultaneously along with a physical task and/or a computational function task, wherein the data collection task performed may or may not be related to the physical and/or computational function tasks. In other words, a robot 102 performing the data collection task based on an instruction from a cloud server 202 may execute other instructions form the cloud server 202 while simultaneously performing the data collection task.

One skilled in the art would appreciate that the store 600 may be illustrative of any environment in which a robot 102 operates, and the robot 102 may additionally collect data of any feature of its environment based on an instruction received from a cloud server 202 and is not intended to be limiting. For example, an operator input may request a robot 102 to measure Wi-Fi signal strength within an environment, wherein the robot 102 may navigate around the environment and collect data of the Wi-Fi signal strength using a sensor. In other words, FIG. 6 is illustrative of a data collection task for a robot 102 based on a received instruction from a cloud server 202. Additionally, FIG. 6 is illustrative of a single robot 102 performing a data collection task which may be expanded upon to include a plurality of robots 102 performing a plurality of data collection tasks in response to an instruction from a cloud server 202.

FIG. 7A illustrates a plurality of robots 102, comprising robotic fork lifts, receiving an instruction 702 from a cloud server 202 (not shown), the instruction comprising a physical task to be performed by the robots 102, according to an exemplary embodiment. The physical task for the robots 102 to perform may include retrieving pallets 706 from a designated pick-up zone 704 and bringing the pallets 706 to a drop-off zone 708. The instruction 702 may designate the pick-up zone 704, drop-off zone 708, and the items to be retrieved (e.g., the pallets 706). Controllers 118 of the plurality of robots 102 may determine routes 710 for the robots 102 to follow to accomplish the task (e.g., retrieve pallets 706) received by the instruction, as illustrated below in FIG. 7B.

According to at least one non-limiting exemplary embodiment, the instruction may further include routes 710, illustrated in FIG. 7B, for the robots 102 to follow.

According to at least one non-limiting exemplary embodiment, the plurality of robots 102 may receive the instruction 702 at a plurality of different locations. In other words, the locations at which the plurality of robots 102 receive the instruction 702 as illustrated is not intended to be limiting. Similarly, the plurality of robots 102 may receive the instruction 702 at different times such as, for example, in the case where one or more robots 102 are finishing other tasks prior to executing the instruction 702.

One skilled in the art would appreciate that additional or fewer robots 102 than illustrated may be utilized by a cloud server 202 to perform the task of moving the pallets 706 from the pick-up zone 704 to the drop-off zone 708.

FIG. 7B illustrates the plurality of robots 102, illustrated above in FIG. 7A, navigating routes 710 to accomplish a task of retrieving pallets 706 from a pick-up zone 704 and bringing them to a drop off zone 708, according to an exemplary embodiment. Routes 710 may be determined by a controller 118 of the robots 102 or may be given to the robots 102 as part of a received instruction from a cloud server 202. The plurality of robots 102 may follow the route 710 to move the pallets 706 from the pick-up zone 704 to the drop-off zone 708. According to at least one non-limiting exemplary embodiment, additional or fewer routes 710 may be utilized by the robots 102 to accomplish the task of moving the pallets 706.

According to at least one non-limiting exemplary embodiment, the robots 102 may collect data from a plurality of sensor units 114 to respond to other instructions from the cloud server 202 while simultaneously performing the physical task of moving the pallets 706. For example, the cloud server 202 may distribute an instruction of moving the pallets 706 and an instruction of localizing nearby objects within the environment of the robots 102, wherein while performing the physical task the plurality of robots 102 may further detect and localize any nearby objects as the robots 102 travel route 710.

As the robots 102 move the pallets 706, they may send wireless signals 712 to the cloud server 202 and/or to other robots 102 in the same environment. The signals comprising, for example, sensor data from sensor units 114 collected as the robots 102 perform the task of moving the pallets 706 (e.g., weight of the pallets 706, a number of pallets 706 moved, etc.). Data received by the wireless signals 712 may be utilized by the cloud server 202 or the robots 102 to respond to future operator inputs 302. According to at least one non-limiting exemplary embodiment, data collected during execution of a task may be communicated to a cloud server 202 upon completion of the task, illustrated below in FIG. 7C.

FIG. 7C illustrates the plurality of robots 102, illustrated above in FIG. 7A-B, sending wireless signals 712 upon completion of a physical task of moving pallets 706 from a pick-up zone 704 to a drop off zone 708, according to an exemplary embodiment. The wireless signals 712 may communicate to a cloud server 202 that the physical task of moving the pallets 706 to the drop off zone 708 has been completed.

According to at least one non-limiting exemplary embodiment, wireless signals 712 may further communicate data collected by sensor units 114 and/or controller 118 of the robots 102 during execution of a task. For example, the robots 102 may communicate data comprising localization of the pallets 706 within the drop-off zone 708, sensor data of detected objects along a route 710 illustrated in FIG. 7B (e.g., localization of any objects detected as the robots 102 perform the task), and/or any other data from the sensor units 114 or controller 118 (e.g., any computations performed based on the sensor data). This data may be utilized by a cloud server 202 to generate future instructions based on the new location of the pallets 706.

FIG. 7A-C illustrate an exemplary physical task performed by a distributed system of robots 102, the physical task comprising moving objects from one point to another, wherein the pallets 706 may be illustrative of any object to be moved by the robots 102. One skilled in the art would appreciate that a physical task may include tasks other than moving objects. For example, an instruction received by a cloud server 202 may configure the robots 102 to clean a floor if the robots 102 comprise robotic floor cleaners, wherein zones 704 and 708 may be illustrative of dirty floor zones to be cleaned by the robotic floor cleaners. Advantageously, the use of a distributed system of robots 102 to perform a physical task may lessen the amount of work required by an individual robot 102 to perform the physical task and reduce the time for completing the physical task (e.g., using multiple robots 102 to move multiple pallets 706 simultaneously).

According to at least one non-limiting exemplary embodiment, a physical task may be performed simultaneously along with a data collection task and/or a computational function task, wherein the physical task performed may or may not be related to the data collection and/or computational function tasks. In other words, a robot 102 performing the physical task based on an instruction from a cloud server 202 may execute other instructions form the cloud server 202 while simultaneously performing the physical task.

FIG. 8 is a functional block diagram illustrating a process flow of data for a plurality of controllers 118, of a plurality of corresponding robots 102, to receive an instruction comprising a computational function to be performed by the plurality of controllers 118, according to an exemplary embodiment. The plurality of robots 102 comprising the controllers 118 may form a robot network 304 (illustrated by a dashed box around the controllers 118), as illustrated above in FIG. 3. Each controller 118 may be configurable to execute computer readable instructions received by the instruction from a cloud server 202 or computer readable instructions within a memory 120 of the robots 102, illustrated in FIG. 1A, based on an instruction from the cloud server 202.

Operator input 302 may be received by a processing device 130 of a cloud server 202 from an external device 206, illustrated above in FIG. 2. The operator input may comprise a request for a computational function to be performed by the cloud server 202. A computational function may include, for example, calculating one or more values based on mathematical or logical algorithms, calculating one or more values based on sensor data, and/or executing computer readable instructions (e.g., from memory 120 of the robots 102 or computer readable instructions received from the cloud server 202). Processing device 130, of the cloud server 202, may determine an instruction to be sent to the robot network 304 to configure the controllers 118, of the plurality of robots 102 on the robot network 304, to perform the computational function. The instruction may comprise computer readable instructions to be executed by the controllers 118; pointers to locations in memory 120, the locations comprising computer readable instructions to be executed by the controllers 118; and/or one or more values to be calculated by the controllers 118 based on mathematical or logical operations determined by the controllers 118 (i.e., the controllers 118 may be configurable to determine how to calculate the one or more values). The instruction may be sent by the cloud server 202 via communications 802 and received by the controllers 118 using communications units 116 (not shown) of the robots 102. Communications 802 may comprise wireless communications.

Upon completion of the computational function received by the instruction, the controllers 118 may output one or more values back to the processing device 130 of the cloud server 202 via communications 804, the one or more values calculated by the controllers 118 based on the instruction received by the cloud server 202. The processing device 130 may utilize the computed one or more values to determine an operator output 306.

According to at least one non-limiting exemplary embodiment, a computational function may be performed simultaneously with a data collection task and/or a physical task, wherein the computational function performed may or may not be related to the data collection and/or physical tasks. In other words, a robot 102 performing the computational function based on an instruction from a cloud server 202 may execute other instructions form the cloud server 202 while simultaneously performing the computational function if the robot 102 is capable of doing so.

Advantageously, the use of a distributed network of controllers 118 performing computational functions requested by an operator input 302 may increase the efficiency of the computation by distributing smaller computational functions to the network of controllers 118. By having a plurality of individual controllers 118 executing smaller computational functions, or a sub-set of computational functions of a larger computational function, the computational function requested by the operator input 302 may be performed significantly faster as compared to a single processing device 130 performing the computational function. Additionally, distributing computational work to a plurality of controllers 118 may further lessen the computational workload to a single processing device, such as the processing device 130 of the cloud server 202.

FIG. 6-8 illustrate three types of tasks for a robot network 304 to accomplish based on an instruction from a cloud server 202, the instruction from the cloud server 202 being based on an operator input 302. The three types of tasks include data collection, performing a physical task, and performing a computational function using a distributed robot network 304. These three types of tasks are not intended to be limiting, wherein the types of tasks performed by the distributed robot network 102 may only be limited by the functionality (i.e., capability) of the robots 102. One skilled in the art would appreciate an operator input 302 may require a combination of data collection, physical tasks, and/or computational functions to be performed by one or more robots 102 on a robot network 304 for a cloud server 202 to generate an operator output 306, the operator output 306 generated in response to the operator input 302 based on data from the robot network 304. Additionally, a plurality of instructions may comprise, at least in part, similar or the same tasks to be performed, wherein a robot network 304 may perform the plurality of tasks to simultaneously execute, at least in part, the plurality of instructions simultaneously as illustrated below in FIG. 10.

According to at least one non-limiting exemplary embodiment, robots 102 on a robot 102 network 304 may be preconfigurable to perform a set of tasks, such as a cleaning robot cleaning along a predetermined route, while simultaneously performing tasks based on an instruction from a cloud server 202. For example, a processing device of a cleaning robot 102 may be used by a cloud server 202 to perform a computational function if the processing device comprises the specifications (e.g., extra bandwidth) to do so. Similarly, as another example, the same cleaning robot 102 may also be used to collect data of features of a surrounding environment while simultaneously cleaning. The below FIG. 9 illustrates a data set used by a cloud server 202 to distribute tasks to robots 102 on a robot network 304.

FIG. 9 illustrates a data table 900 comprising data on a plurality of robots 102 on a robot network 304 and properties thereof, according to an exemplary embodiment. Each robot 102 may be assigned a robot ID distinguishing each of the plurality of robots 102. Each robot 102 may comprise a plurality of properties including, but not limited to, properties of a processing device of each robot 102 (e.g., clock rate, number of cores, etc.), a maximum speed of the robots 102 (e.g., meters per second, feet per second, etc.), a number of cameras on the robots 102, a functionality of the robots 102, and/or any other additional properties of the robots 102. Data table 900 may comprise N robots, wherein index N may be any non-zero integer number corresponding the number of robots 102 on the robot network 304. Similarly, index I may correspond to an arbitrary integer number of cameras on the N^{th} robot 102 greater than or equal to zero. Data table 900 may be stored in a memory 132 of a cloud server 202 and may be accessed by a processing device 130 of the cloud server 202 to determine and distribute instructions to the plurality of robots 102 on the robot network 304.

For example, an operator input 302 may include a request for finding and cleaning dirty regions of a floor within an environment. A processing device 130 of a cloud server 202 may access the data table 900 to determine an instruction for robot 2 and robot 3, comprising a floor scrubber and vacuum respectively, to find the locations of the dirty floor and clean the dirty regions of the floor. In another example, a request from a user may comprise, at least in part, a computational function to be performed by a cloud server 202, wherein the cloud server 202 may distribute larger portions of the computational function to a plurality of robots 102 comprising faster processors. Other operations may be performed using properties of a plurality of robots 102 of a robot network 304 stored in a data table 900.

According to at least one non-limiting exemplary embodiment, a cloud server 202 may utilize different robots 102 at different times to generate an operator response 306 to an operator input 302. For example, a task may comprise first completing a data collection task, wherein the cloud server 202 may generate an instruction to robots with sensors and/or cameras best suited for the physical task. The task, following the above example, may further comprise performing a computational function based on data collected during the data collection task, wherein the cloud server 202 may utilize robots with fast processors to perform the computational function. The robots performing the first data collection task and the second computational function task may be the same or different robots.

According to at least one non-limiting exemplary embodiment, data table 900 may be displayed to a human operator on a user interface device (e.g., an external device 206 illustrated in FIG. 2), wherein the human operator may specify some robots 102, of the plurality of robots 102 in the data table 900, to perform a task based on the properties of the specified robots 102.

One skilled in the art would appreciate data table 900 may be a self-referential data table, wherein additional rows and columns may be added or removed as a processing device 130 of a cloud server 202 executes computer readable instructions in memory 132 and/or as additional robots 102 are added to a robot network 304. Advantageously, a data table 900 comprising a plurality of functions of robots 102 on a robot network 304 may enhance the ability of a processing device 130 of a cloud server 202 to distribute instructions, in response to an operator input 302, to a plurality of robots 102 best suited to execute the distributed instructions.

FIG. 10 illustrates a data table 1000 comprising a plurality of instructions and tasks to be performed by robots 102 on a robot network 304 to respond to the instructions, according to an exemplary embodiment. Table 1000 may be illustrative of a queue stored in memory 132 of a cloud server 202 or memory 120 of the robots 102, the queue may be configurable to handle a plurality of instructions from a cloud server 202 based on associated tasks. The plurality of instructions 1 to N may correspond to operator input 302 as shown in and discussed in correspondence with FIGS. 3, 4 and 8. As illustrated in table 1000, some instructions may comprise one or more of the same tasks as other instructions (e.g., instruction 2, 4, and 6 all comprise task 5), wherein each task may comprise a physical task, a data collection task, or a computational function to be performed. The instructions may be generated based on an operator input 302, as illustrated above in FIG. 4.

Some tasks in the table 1000 may further comprise tasks, which may be completed simultaneously. For example, cloud server 202 may receive a plurality of instructions, or operator input, simultaneously or consecutively in real-time. These plurality of instructions may correspond to various instructions (i.e., instruction 1 to instruction N). Wherein, instruction 1 comprise task 1, task 2, task 3, and task 4, for example. Task 1 may include a robot moving an item and task 2 may include the robot 102 performing a computational function based on data collected during task 1 or data collected while performing other tasks, wherein the robot 102 may perform the two tasks simultaneously by performing the computational function of task 2 while moving the item of task 1. One skilled in the art would appreciate task 2 in the above example may be representative of any task in table 1000 (e.g., task 2-13) for the same or separate instruction which a robot 102 may perform while simultaneously performing task 1. A robot 102 executing instruction 1, and performing the comprising tasks 1-4, may collect data and/or perform tasks to satisfy, at least in part, other instructions in the queue. The robot 102 may execute instruction 1 first and may perform subsequent instructions after execution of instruction 1.

According to at least one non-limiting exemplary embodiment, upon completion of instruction 1, a controller 118 of a robot 102 or processing device 130 of a cloud server 202 may rearrange the queue based on tasks performed during instruction 1. That is, the instructions within the queue may not remain in a fixed order over time as the instructions are executed by one or more robots. For example, completion of instruction 1 comprises a robot 102 performing tasks 1-4, wherein the same robot 102, or a different robot in the robot network 304, may secondly execute instruction 6, which comprises execution of tasks 1, 3, 4 and 5. Since tasks 1, 3, and 4, were already completed upon execution of instruction 1, the only remaining task that needs to be performed is task 5. As such, the same or different robot 102 in the robot network 304 may only be required to perform one additional task 5 to satisfy instruction 6, as tasks 1, 3, and 4 were already completed during execution of instruction 1. By way of illustrative example, a robot network may assign a high level task comprising of sub-tasks including (i) cleaning a floor, (ii) scanning a shelf for an item, and (iii) observing foot traffic within a retail store. A first robot 102 may clean the floor while simultaneously observing foot traffic (i.e., counting people). A second robot 102, upon the first robot 102 completing tasks (i) and (iii), may only be required to scan the shelf for the item to complete the high level task assigned by the network.

According to at least one non-limiting exemplary embodiment, some tasks may be performed based on data collected during other tasks or performed simultaneously with other tasks. For example, task 6 of instruction 2 may be performed simultaneously based on data collected during task 2 and 3, thereby enabling a robot 102 to simultaneously execute tasks of instruction 2 in real-time while executing tasks of instruction 1. One or more robots 102 in the robot network 304 may utilize the table 1000 stored in memory to determine any tasks for other instructions, which may be performed simultaneously during execution of a current instruction.

According to at least one non-limiting exemplary embodiment, wherein data table 1000 is stored in memory 132 of a cloud server 202, the cloud server 202 may access the data table 1000 to distribute tasks to robots 102 in a robot network 304 best suited to perform the task. Similarly, the cloud server 202 may access the data table 1000 to distribute tasks to the robots 102 on the robot network to satisfy a plurality of instructions simultaneously. For example, instruction 1 and its comprising tasks may be assigned to a first set of robots 102, instruction 2 and its comprising tasks may be assigned to a second set of different robots 102, and so forth. Additionally, the cloud server 202 may utilize data from completed tasks during execution of some instructions to satisfy, at least in part, other instructions and their comprising tasks.

Advantageously the use of a queueing system, or similar system of storing a plurality of instructions and comprising tasks, may enhance the efficiency of robots 102 executing instructions from a cloud server 202 as the robots 102 may utilize data collected during execution of a first instruction, and comprising tasks, to more efficiently and quickly execute later instructions. Additionally, a plurality of instructions may comprise substantially similar or the same tasks as other instructions within the queue, wherein a robot 102 may respond to the plurality of instructions simultaneously while performing a task only once.

One skilled in the art would appreciate data table 1000 may be a self-referential data table, wherein additional rows and columns may be added or removed as a processing device 130 of a cloud server 202 or controller 118 of a robot 102 executes computer readable instructions in memory 132 or memory 120, respectively, and/or as additional instructions are added to a queue of instructions based on additional operator inputs 302 being received by the cloud server 202. Additionally, the plurality of instructions illustrated in table 1000 may comprise the same number of tasks or a different number of tasks, wherein the arrangement and number of the tasks and corresponding instructions illustrated in the table 1000 is not intended to be limiting.

According to example embodiments disclosed herein, they are directed to systems, methods and non-transitory computer readable media wherein at least one processing device is configurable to execute computer readable instructions to receive an operator input comprising instructions for a robot network, the robot network comprising a plurality of independently operable robots that are communicatively coupled to each other in an environment; transmit the instructions to at least a first sub-set of robots in the robot network such that the first sub-set of robots execute the instructions in the environment, the instructions comprising a plurality of tasks to be performed by the first sub-set of robots such that a respective task of the plurality of tasks is assigned to a respective robot of the first sub-set of robots based on bandwidth of the respective robot; receive data collected by the first sub-set of robots during simultaneous performance of the plurality of tasks by the first sub-set of robots in the environment; and generate an operator output based on the data collected by the first sub-set of robots.

Further, wherein the at least one controller is further configurable to execute the computer readable instructions to, transmit the instructions to the first sub-set of robots in the robot network only if response to the operator input is not previously stored in the memory. Additionally, wherein the transmission of the instructions to the first sub-set of robots configures the respective robot to, navigate from a first location to a second location and collect data on one or more items at the second location, and transmit the data collected on the one or more items to the at least one controller.

According to example embodiments, wherein the transmission of the instructions to the first sub-set of robots configures the respective robot to, retrieve one or more items from a designated pick-up location and drop the one or more items at a designated drop-off location, and transmit data to the at least one controller simultaneously as the one or more items are relocated from the pick-up location to the drop-off location. And, wherein the transmission of the instructions to the first sub-set of robots configures the respective robot to, receive a plurality of operator inputs, each of the plurality of operator inputs comprises a plurality of tasks to be performed by set of the plurality of robots; wherein the respective robot of the plurality of robots performs the respective task in the plurality of tasks only if the respective task is not previously performed by a different robot assigned the respective task via a respective operator input.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but, rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A non-transitory computer readable storage medium having computer readable instructions stored thereon, that when executed by at least one controller, configure the at least one controller to,
receive an operator input comprising instructions for a robot network, the robot network comprising a plurality of independently operable robots that are communicatively coupled to each other in an environment;
transmit the instructions to at least a first sub-set of robots in the robot network such that the first sub-set of robots execute the instructions in the environment, the instructions comprising a plurality of tasks to be performed by the first sub-set of robots such that a respective task of the plurality of tasks is assigned to a respective robot of the first sub-set of robots based on bandwidth of the respective robot;
receive data collected by the first sub-set of robots during simultaneous performance of the plurality of tasks by the first sub-set of robots in the environment; and
generate an operator output based on the data collected by the first sub-set of robots.

2. The non-transitory computer readable storage medium of claim 1, wherein the at least one controller is further configurable to execute the computer readable instructions to,
transmit the instructions to the first sub-set of robots in the robot network only if response to the operator input is not previously stored in the memory.

3. The non-transitory computer readable storage medium of claim 1, wherein the transmission of the instructions to the first sub-set of robots configures the respective robot to,
navigate from a first location to a second location and collect data on one or more items at the second location, and
transmit the data collected on the one or more items to the at least one controller.

4. The non-transitory computer readable storage medium of claim 1, wherein the transmission of the instructions to the first sub-set of robots configures the respective robot to,
retrieve one or more items from a designated pick-up location and drop the one or more items at a designated drop-off location, and
transmit data to the at least one controller simultaneously as the one or more items are relocated from the pick-up location to the drop-off location.

5. The non-transitory computer readable storage medium of claim 1, wherein the transmission of the instructions to the first sub-set of robots configures the respective robot to,
receive a plurality of operator inputs, each of the plurality of operator inputs comprises a plurality of tasks to be performed by set of the plurality of robots.

6. The non-transitory computer readable storage medium of claim 5, wherein the respective robot of the plurality of robots performs the respective task in the plurality of tasks only if the respective task is not previously performed by a different robot assigned the respective task via a respective operator input.

7. The non-transitory computer readable storage medium of 5, wherein each robot updates other robots in the plurality of robots upon completion of the respective task assigned to the respective robot.

8. The non-transitory computer readable storage medium of 1, wherein
the respective task of the plurality of tasks are assigned based at least on functionality and capabilities of the respective robot, and
the plurality of tasks include at least one of data collection, physical tasks and computational functions.

9. A method for distributing tasks, comprising:
receiving an operator input comprising instructions for a robot network, the robot network comprising a plurality of independently operable robots that are communicatively coupled to each other in an environment;
transmitting the instructions to at least a first sub-set of robots in the robot network such that the first sub-set of robots execute the instructions in the environment, the instructions comprising a plurality of tasks to be performed by the first sub-set of robots such that a respective task of the plurality of tasks is assigned to a respective robot of the first sub-set of robots based on bandwidth of the respective robot;
receiving data collected by the first sub-set of robots during simultaneous performance of the plurality of tasks by the first sub-set of robots in the environment; and
generating an operator output based on the data collected by the first sub-set of robots.

10. The method of claim 9, further comprising:
transmitting the instructions to the first sub-set of robots in the robot network only if response to the operator input is not previously stored in the memory.

11. The method of claim 9, further comprising:
navigating from a first location to a second location and collect data on one or more items at the second location; and
transmitting the data collected on the one or more items to at least one controller.

12. The method of claim 9, further comprising:
retrieving one or more items from a designated pick-up location and drop the one or more items at a designated drop-off location; and
transmitting data to the at least one controller simultaneously as the one or more items are relocated from the pick-up location to the drop-off location.

13. The method of claim 9, wherein the transmission of the instructions to the first sub-set of robots configures the respective robot to,
receive a plurality of operator inputs, each of the plurality of operator inputs comprises a plurality of tasks to be performed by set of the plurality of robots.

14. The method of claim 13, wherein the respective robot of the plurality of robots performs the respective task in the plurality of tasks only if the respective task is not previously performed by a different robot assigned the respective task via a respective operator input.

15. The method of claim 13, wherein each robot updates other robots in the plurality of robots upon completion of the respective task assigned to the respective robot.

16. A system for distributing tasks, comprising:
a memory having computer readable instructions stored thereon; and
at least one controller configurable to execute the computer readable instructions to,
receive an operator input comprising instructions for a robot network, the robot network comprising a plurality of independently operable robots that are communicatively coupled to each other in an environment;
transmit the instructions to at least a first sub-set of robots in the robot network such that the first sub-set of robots execute the instructions in the environment, the instructions comprising a plurality of tasks to be performed by the first sub-set of robots such that a respective task of the plurality of tasks is assigned to a respective robot of the first sub-set of robots based on bandwidth of the respective robot;
receive data collected by the first sub-set of robots during simultaneous performance of the plurality of tasks by the first sub-set of robots in the environment; and
generate an operator output based on the data collected by the first sub-set of robots.

17. The system of claim 16, wherein the transmission of the instructions to the first sub-set of robots configures the respective robot to,
receive a plurality of operator inputs, each of the plurality of operator inputs comprises a plurality of tasks to be performed by set of the plurality of robots.

18. The system of claim 17, wherein the respective robot of the plurality of robots performs the respective task in the plurality of tasks only if the respective task is not previously performed by a different robot assigned the respective task via a respective operator input.

19. The system of claim 17, wherein each robot updates other robots in the plurality of robots upon completion of the respective task assigned to the respective robot.

20. The system of claim 16, wherein
the respective task of the plurality of tasks are assigned based at least on functionality and capabilities of the respective robot, and
the plurality of tasks include at least one of data collection, physical tasks and computational functions.
